(19) United States
(12) Patent Application Publication
(10) Pub. No.: US 2024/0404729 A1
(43) Pub. Date: Dec. 5, 2024

(54) GROUNDING RESISTANCE AND GROUND ROD CORROSION REDUCER

(71) Applicant: SUNKWANG LIGHTNING PROTECTION TECHNICAL INSTITUTE INC., Seoul (KR)

(72) Inventors: Dong-Jin KIM, Seoul (KR); Wan-Sung KWON, Seoul (KR); Sang-Won SEO, Seoul (KR); Yong-Su KIM, Seoul (KR); Sung-Joon LEE, Seoul (KR); Jae-Sang YOO, Seoul (KR)

(21) Appl. No.: 18/518,398

(22) Filed: Nov. 22, 2023

(30) Foreign Application Priority Data
May 30, 2023 (KR) 10-2023-0068846

(51) Int. Cl. H01B 7/28; H01B 3/02

(52) U.S. Cl. CPC H01B 7/2806; H01B 3/025

(57) ABSTRACT

A grounding resistance and ground rod corrosion reducer that is capable of making use of montmorillonite, smectite, and vermiculite to apply antacid effect to acidified grounding environments, thereby decreasing a corrosion rate of a ground rod and providing an excellent grounding resistance reduction rate. The grounding resistance and ground rod corrosion reducer contains 50 to 75% by weight of a grounding resistance soil mixture made up of the montmorillonite, the smectite, and the vermiculite, 20 to 40% by weight of magnesium hydroxide, and 5 to 15% by weight of graphite, based on the total weight thereof.

### CROSS REFERENCE

The present application claims the benefit of Korean Patent Application No.10-2023-0068846 filed in the Korean Intellectual Property Office on 30 May 2023, the entire contents of which are incorporated herein by reference.

### BACKGROUND

The present disclosure relates to a grounding resistance and ground rod corrosion reducer that is capable of making use of montmorillonite, smectite, and vermiculite to apply antacid effect to acidified grounding environments, thereby decreasing a corrosion rate of a ground rod and providing an excellent grounding resistance reduction rate.

Generally, the purpose of grounding is to prevent accidents from happening owing to an invisible electric current. However, such grounding is invisible, so that it is easy to overlook its importance. Further, as the accidents do not happen all the time, grounding may be performed without clear plans. However, if grounding is poor, accidents whose bottoms are difficult to get may happen frequently, and therefore, a lot of carefulness is required in performing the grounding. Besides, if the temporary failure of electrical equipment occurs due to grounding problems, economic loss may be quite large, and therefore, the grounding has to be done carefully. Because of such reasons, it is important to install a grounding electrode.

The grounding is performed by installing ground rods in the ground by means of parallel grounding, mesh construction, a boring method, and a deep drilling method according to its designs. However, since ground soil has many factors due to its properties, it is very difficult to obtain a required grounding resistance value as designed.

The grounding resistance value is closely related with the length, cross sectional area, contact area, and buried depth of the grounding electrode. If grounding using ground rods, copper plates, and bare copper wires is performed, it is advantageous that the sizes of the ground rods, the copper plates, and the bare copper wires are as big as possible. In the past, grounding resistances were easily obtained using grounding electrodes such as Pannet and Parrotus. As electrical equipment has been developed, in recent years, the use of such grounding electrodes is facing limitations due to the demand for low grounding resistance value. Therefore, the grounding is designed by investigating the characteristics of the ground in various ways, and even under such design, it is very difficult to obtain the required grounding resistance value.

In addition, to lower the grounding resistance, it is important that the grounding electrode is made as long and large as possible and a good quality of ground is chosen. However, there is a difficulty in choosing a good quality of ground because the quality of ground depends on the construction site. Further, if the long and large grounding electrode is made, the use of an artificial grounding resistance reducer becomes important as the burden of a construction cost increases.

An artificial method is a method for reducing the resistivity of the soil by injecting or replacing a conductive material or a chemical electrolyte material in the soil around the grounding electrode. The artificial method was suggested quite a long time ago and made use of a combination of salt, ammonium sulfate, sodium carbonate, carbon powder, belite, and bentonite. In some cases, ash, charcoal, manure, graphite, calcium chloride, magnesium chloride, and cokes were also used. Immediately after such materials are used, the grounding resistance value is clearly lowered, but as time passes, the grounding resistance value gradually increases. After 1 to 2 years, the grounding resistance reducing effect almost disappears. The reason for this is that these materials are filled in the pores among soil particles to temporarily lower the resistivity of the soil. However, these materials have no adhesive force and are thus dissolved in water, so that they are easily extinguished by rainwater or underground water. In addition, if the grounding electrode is a metal, it may corrode, so that at present, these materials are not used anymore.

### SUMMARY OF THE INVENTION

Accordingly, the present disclosure has been made in view of the above-mentioned problems occurring in the related art, and it is an object of the present disclosure to provide a grounding resistance and ground rod corrosion reducer that is capable of making use of montmorillonite, smectite, and vermiculite to apply antacid effect to acidified grounding environments, thereby decreasing a corrosion rate of a ground rod and providing an excellent grounding resistance reduction rate.

To accomplish the above-mentioned object, according to the present disclosure, there is provided a grounding resistance and ground rod corrosion reducer including a grounding resistance soil mixture made up of montmorillonite, smectite, and vermiculite, magnesium hydroxide, and graphite.

According to the present disclosure, desirably, 75 to 90% by weight of the montmorillonite, 5 to 15% by weight of the smectite, and 5 to 15% by weight of the vermiculite may be contained, based on the total weight of the grounding resistance soil mixture.

According to the present disclosure, desirably, 50 to 75% by weight of the grounding resistance soil mixture made up of the montmorillonite, the smectite, and the vermiculite, 20 to 40% by weight of the magnesium hydroxide, and 5 to 15% by weight of the graphite may be contained, based on the total weight of the grounding resistance and ground rod corrosion reducer.

### DETAILED DESCRIPTION OF THE PREFERRED EMBODIMENTS

Hereinafter, the present disclosure will be described in detail.

A grounding resistance and ground rod corrosion reducer according to the present disclosure contains a grounding resistance soil mixture made up of montmorillonite, smectite, and vermiculite, magnesium hydroxide, and graphite.

The montmorillonite contained in the grounding resistance soil mixture absorbs water and thus swells seven to ten times, and further, the montmorillonite has excellent positive ion exchangeability. When it has water content of 150%, it has an adhesive force. In this case, the montmorillonite contained in the grounding resistance soil mixture is present in an amount of 75 to 90% by weight, based on the total weight of the grounding resistance soil mixture. If the content of the montmorillonite is too small, adhesion effect may be deteriorated, and on the contrary, if the content of the montmorillonite is too large, effect in improving conductivity may not be obtained.

The smectite contained in the grounding resistance soil mixture has excellent adhesion strength, chloride invasion resistance, acid resistance, and alkali resistance, and the smectite contained in the grounding resistance soil mixture is present in an amount of 5 to 15% by weight, based on the total weight of the grounding resistance soil mixture. If the content of the smectite is too small, conductivity may be deteriorated, and on the contrary, if the content of the smectite is too large, initial strength may decrease.

The vermiculite contained in the grounding resistance soil mixture serves to buffer chemical reactions, and the vermiculite is present in an amount of 5 to 15% by weight, based on the total weight of the grounding resistance soil mixture. If the content of the vermiculite is less than 5% by weight, the buffering effect for the chemical reactions may become weak, and on the contrary, if the content of the vermiculite is over 15% by weight, strength may decrease.

In this case, desirably, the grounding resistance soil mixture made up of the montmorillonite, the smectite, and the vermiculite is present in an amount of 50 to 75% by weight, based on the total weight of the grounding resistance and ground rod corrosion reducer. If the grounding resistance soil mixture is less than 50% by weight, a grounding resistance may be lowered.

Magnesium oxide reacts with water to produce magnesium hydroxide, and magnesium hydroxide lowers corrosion effect on acidified soil. Desirably, the magnesium hydroxide is present in an amount of 20 to 40% by weight, based on the total weight of the grounding resistance and ground rod corrosion reducer. If the content of the magnesium hydroxide is less than 20% by weight, a corrosion reduction rate may be lowered, and on the contrary, if the content of the magnesium hydroxide is over 40% by weight, electrical conductivity of the grounding resistance and ground rod corrosion reducer may decrease.

Graphite is low in its own resistance to provide excellent conductivity, and if the graphite receives water from the montmorillonite, it is distributed evenly to the entire of the grounding resistance and ground rod corrosion reducer and smoothly discharges grounding current supplied to a grounding line. Desirably, the graphite is present in an amount of 5 to 15% by weight, based on the total weight of the grounding resistance and ground rod corrosion reducer. If the content of the graphite is less than 5% by weight, effect in improving electrical conductivity of the grounding resistance and ground rod corrosion reducer may be slight, and on the contrary, if the content of the graphite is over 15% by weight, the weight percentage of the soil mixture may become lowered to cause the function of the grounding resistance to be lost.

Hereinafter, an embodiment of the present disclosure will be explained in detail, but the present disclosure may not be limited thereto.

### EMBODIMENT

First, 80% by weight of montmorillonite, 10% by weight of smectite, and 10% by weight of vermiculite were mixed to produce a grounding resistance soil mixture. Next, 65% by weight of the produced grounding resistance soil mixture, 25% by weight of magnesium hydroxide, and 10% by weight of graphite were mixed to produce a grounding resistance and ground rod corrosion reducer according to the embodiment of the present disclosure.

### Experimental Example 1

To check pH increasing effect of the grounding resistance and ground rod corrosion reducer, experiments were carried out. The Lutron PH-220S was used as a soil pH meter.

To conduct the experiments, an area with a width of 1 m, a depth of 1 m, and a length of 3 m was excavated on the ground, and next, a BC 100 mm² wire was fixed to the bottom. After that, the grounding resistance and ground rod corrosion reducer was laid on top of the wire and filled back with soil. In a comparative example, bentonite was laid under the same condition as above.

Next, pH of the grounding resistance and ground rod corrosion reducer according to the embodiment of the present disclosure and pH of the bentonite according to the comparative example were measured and listed in Table 1.

TABLE 1

| | Measured pH value |
|---|---|
| Embodiment of the present disclosure | 8.96 |
| Comparative example | 7.12 |

As appreciated from Table 1, it was checked that the pH of the grounding resistance and ground rod corrosion reducer according to the embodiment of the present disclosure was 8.96, and accordingly, the grounding resistance and ground rod corrosion reducer had higher alkalinity than the bentonite according to the comparative example. If the soil mixture was laid on acidified soil, it performs a buffering action to reduce the corrosion rate of a ground rod.

### Experimental Example 2

To check grounding resistance reduction effect according to the adhesion force of the grounding resistance and ground rod corrosion reducer to soil, grounding resistance experiments were carried out.

To conduct the experiments, ground resistivity was first measured using a four point meter. In this case, the Biddle DET2/2 digital ground resistance tester was used as the four point meter, and a fall of potential method was used as a measurement method.

In the same manner as the experimental example 1, the grounding resistance and ground rod corrosion reducer according to the embodiment of the present disclosure and the bentonite according to the comparative example were laid, and next, grounding resistances & after the laying were measured to represent reduction values and rates thereof in Table 2.

TABLE 2

| | Grounding | Grounding | | |
|---|---|---|---|---|
| | resistance in | resistance | Reduction | |
| | basic state | after laying | value | Reduction rate |
| Embodiment of | 468 Ω | 96 Ω | 372 Ω | 79.49% |
| the present | | | | |
| disclosure | | | | |
| Comparative | 373 Ω | 82 Ω | 291 Ω | 78.02% |
| example | | | | |

As appreciated from Table 2, it was checked that the grounding resistance of the grounding resistance and ground rod corrosion reducer according to the embodiment of the present disclosure was reduced to about 79.49% and the grounding resistance of the bentonite according to the comparative example was reduced to about 78.028. Accordingly, it can be found that the grounding resistance and ground rod corrosion reducer according to the embodiment of the present disclosure has excellent grounding resistance reduction effect, and if lightning current occurs, it is introduced into the ground rod and discharged rapidly to the ground.

As described above, the grounding resistance and ground rod corrosion reducer according to the present disclosure can be easily used in the form of powder and apply the antacid effect to acidified grounding environments, thereby decreasing the corrosion rate of important metal materials such as ground rods to enhance durability of the materials and providing an excellent grounding resistance reduction rate.

While the present disclosure has been described with reference to the particular illustrative embodiments, it is not to be restricted by the embodiments but only by the appended claims. It is to be appreciated that those skilled in the art can change or modify the embodiments without departing from the scope and spirit of the present disclosure.

What is claimed is:

1. A grounding resistance and ground rod corrosion reducer comprising a grounding resistance soil mixture made up of montmorillonite, smectite, and vermiculite, magnesium hydroxide, and graphite.

2. The grounding resistance and ground rod corrosion reducer according to claim 1, wherein 75 to 90% by weight of the montmorillonite, 5 to 15% by weight of the smectite, and 5 to 15% by weight of the vermiculite are contained, based on the total weight of the grounding resistance soil mixture.

3. The grounding resistance and ground rod corrosion reducer according to claim 2, wherein 50 to 75% by weight of the grounding resistance soil mixture made up of the montmorillonite, the smectite, and the vermiculite, 20 to 40% by weight of the magnesium hydroxide, and 5 to 15% by weight of the graphite are contained, based on the total weight of the grounding resistance and ground rod corrosion reducer.

4. The grounding resistance and ground rod corrosion reducer according to claim 3, wherein 80% by weight of the montmorillonite, 10% by weight of the smectite, 10% by weight of the vermiculite are contained, based on the total weight of the grounding resistance soil mixture, and 65% by weight of the grounding resistance soil mixture made up of the montmorillonite, the smectite, and the vermiculite, 25% by weight of the magnesium hydroxide, and 10% by weight of the graphite are contained, based on the total weight of the grounding resistance and ground rod corrosion reducer.
